(19) United States
(12) Patent Application Publication
(10) Pub. No.: US 2025/0106260 A1
(43) Pub. Date: Mar. 27, 2025

(54) Zero-Trust Session Authentication

(71) Applicant: Omnissa, LLC, Mountain view, CA (US)

(72) Inventor: ROHIT PRADEEP SHETTY, Bangalore (IN)

(21) Appl. No.: 18/607,342

(22) Filed: Mar. 15, 2024

(30) Foreign Application Priority Data
Sep. 22, 2023 (IN) 202341063754

(51) Int. Cl. H04L 9/40

(52) U.S. Cl. CPC H04L 63/20; H04L 63/0861; H04L 63/108; H04L 63/1433; H04L 2463/082

(57) ABSTRACT

Various examples are disclosed for a zero-trust authentication model for user sessions. Upon user authentication of a session, security posture assessments can be performed that analyze an ongoing or continuous state of the user, client device, or network conditions. Remedial measures or mitigation procedures can be performed to address potential non-compliance of the session.

### CROSS-REFERENCES

This application claims the benefit of Indian Patent Application number 202341063754, entitled “ZERO-TRUST SESSION AUTHENTICATION,” filed on Sep. 22, 2023, of which is hereby incorporated by reference in its entirety.

### BACKGROUND

Users in enterprise environment are increasingly mobile. Some users may work remotely from home, other users may travel frequently between various offices of an enterprise, and some users might work exclusively on the road from hotels, coffee shops, and the like. Additionally, enterprises are increasingly utilizing device management services to manage user devices. As users move between different locations and on different networks, the risks presented by vulnerabilities can change. Accordingly, zero trust systems often verify other aspects of a user's session, such as the location and network conditions under which the user is connecting to an enterprise system.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of an example of a computing environment according to one example of the disclosure.

FIG. 2 is a drawing showing an example of a computing environment according to one example of the disclosure.

FIG. 3 illustrates initial actions and mitigations according to examples of the disclosure.

FIG. 4 is a flowchart illustrating functionality implemented by components of the environment of FIG. 1.

### DETAILED DESCRIPTION

The present disclosure relates to the zero-trust access control in a computing environment. The computing environment can include client devices and users that are authenticated with an authentication provider or a management service. In some environments, the client devices can be enrolled with a management service as managed devices. A managed device can be managed by a remotely executed management service with a management agent that is installed on the client device. The management agent can be a portion of an operating system of the client device or an application that is installed with elevated privileges on the client device to carry out management tasks on behalf of the management service.

For example, the management service can enforce compliance rules and policies on client devices via operating system application programming interfaces (APIs) that allow for device management features. Compliance rules can include management rules, security rules, and other configuration data for execution by and/or enforcement on the client device. This can include management, security, and other configuration profiles that can include VPN certificates, Wi-Fi profiles, email profiles and other profiles or policies.

The management agent running on a client device can obtain information about the device that can be utilized to continuously evaluate the security posture of a device to enable zero-trust authentication of a user and the client device. Zero trust enabled systems can perform continuous evaluation of user, device and network postures. When a change is detected in any of these postures, a user's access to one or more systems can be paused or blocked until remedial action or mitigations per performed. In many zero trust systems, the actions and/or mitigations required from users are often similar in nature irrespective of the identity of the user.

However, such an approach is at odds with a real-world scenario in which a user with fewer access to enterprise resources than other users. A user with more access to enterprise resources or with access to more important or sensitive enterprise resources might be at a higher risk of causing a data leakage should the user's device or account become compromised. Enforcing stringent mitigation actions on a user with less access to data might result in lesser productivity while also overloading the system. This might lead to employees and corporates viewing a zero trust enabled system as intrusive and a hindrance to productivity.

For example, consider a scenario where a delivery worker with limited access to back-end data is continuously flagged for a location/network change during work hours by a zero trust system. Since the worker's access to confidential data can be negligible due to role-based access controls, prompting the user with multiple mitigations during the day can limit the user's efficiency without really bolstering the security posture of the enterprise.

As users and workforces become increasingly geographically dispersed and increasingly mobile, their locations and other conditions under which the user connects to a given session can change more often. In an enterprise environment that relies upon users to access a computing environment access to these resources is important.

According to various examples provided herein, a computing environment can determine the security posture of a user, a client device from which the user is connecting, network conditions, location of the client device, and other parameters in addition to authentication credentials and secondary authentication factors to provide zero-trust assessment user sessions. Additionally, the user's role or the level of access to enterprise data can also be considered. In other words, a risk level can be attributed to the user in addition to assessing the security posture of the conditions under which the user is connecting to a session. In some examples, the computing environment can take remedial actions on a user session where an ongoing assessment of the session indicates that conditions under which the client device or user is connecting have changed. The remedial actions can include a restricted session, a time-restricted session, or a paused session, among others. The remedial action can also include terminating the session. The remedial action or mitigation can vary depending upon the risk level of the user. Thus, the present application, and the examples described herein, are directed to improving the performance of a computer network, namely, by improving the operation of hosts and related computing resources in a data center that provides, for instance, managed devices and sessions to which these devices can connect.

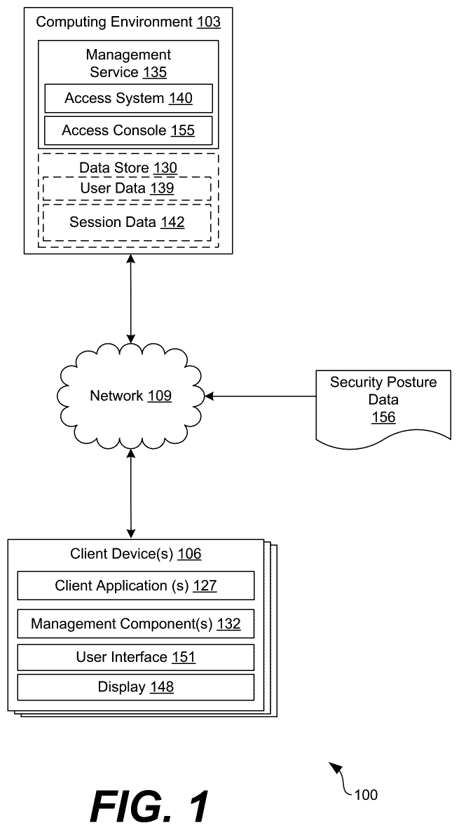

With reference to FIG. 1, an example of a networked environment 100 is shown. The networked environment 100 can include a computing environment 103, a client device 106 (or one or more client devices 106) in communication with one other over a network 109. The network 109 can include, for example, the Internet, intranets, extranets, wide area networks (WANs), local area networks (LANs), wired networks, wireless networks, other suitable networks, or any combination of two or more such networks. For example, the networks can include satellite networks, cable networks, Ethernet networks, telephony networks, and other types of networks.

The computing environment 103 can include, for example, a server computer, or any other system providing computing capability. Alternatively, the computing environment 103 can include a plurality of computing devices that are arranged, for example, in one or more server banks, computer banks, or other arrangements. The computing environment 103 can include a grid computing resource or any other distributed computing arrangement. The computing devices can be located in a single installation or can be distributed among many different geographical locations.

The computing environment 103 can also include or be operated as one or more virtualized computer instances. For purposes of convenience, the computing environment 103 is referred to herein in the singular. Even though the computing environment 103 is referred to in the singular, it is understood that a plurality of computing environments 103 can be employed in the various arrangements as described above. As the computing environment 103 communicates with the client device 106 remotely over the network 109, the computing environment 103 can be described as a remote computing environment 103.

Various applications can be executed in the computing environment 103. For example, a management service 135 as well as other applications, may be executed in the computing environment. Also, various data is stored in a data store 130 that is accessible to the computing environment 103. The data store 130 may be representative of a plurality of data stores 130, which can include relational databases, object-oriented databases, hierarchical databases, hash tables or similar key-value data stores, as well as other data storage applications or data structures. The data stored in the data store 130 is associated with the operation of the various applications or functional entities described below.

The management service 135 can be executed to oversee the operation of client devices 106 enrolled with the management service 135. In some examples, an enterprise, such as a company, organization, or other entity, can operate the management service 135 to oversee or manage the operation of the client devices 106 of its employees, contractors, customers, or other users having accounts with the enterprise. An enterprise can include any customer of the management service 135.

The management service 135 can provide an administrative interface for configuring the operation of the management service 135 and the configuration of client devices 106 that are administered by the management service 135. Accordingly, a management console can correspond to a web page or web application provided by a web server hosted in the computing environment 103. For example, the management console can provide an interface for an administrative user to create configuration profiles to be applied to individual client devices 106, identify application updates that may be required on individual client devices 106, define recommended applications or updates for individual client devices 106, identify security requirements for individual client devices 106, recommend training that is available for users associated with individual client devices 106, as well as various other actions related to the operation of various implementations.

In some examples, the data store 130 can include a database or other memory that includes, for example, user data 139 and session data 142. User data 139 can store or reference information about the user of an enterprise, such as the user's calendar, email, and other user data. Additionally, user data 139 can include usage logs having records of user interactions with a session served up by or monitored by the management service 135 or other types of workloads. User interactions can include, for example, log-on requests, log-off requests, particular actions performed in a session, periods of activity or inactivity, as well as other interactions. Each interaction can be stored in the data store 130 in association with a timestamp describing the time the user interaction was performed. One or more location signals associated with the user's location can also be stored in the data store 130 as user data 139.

Location signals can identify a location of the user as reported by a client device 108 of the user that reports its location data to the management service 135. A location signal can comprise a geographic location of a client device 108, an IP address of a client device 108 that is connected to a session provided or monitored by the management service 135, or a network connection type. A network connection type can identify whether a network connection of the client device 108 is a wired or wired connection, a network provider or domain of the connection, whether the connection is a secure or VPN connection, and other connection properties that can be determined by a management component 132 running on the client device 108 and reported to the management service 135.

Session data 142 can comprise information about user sessions between a client device 108 and a system that is monitored by the management service 135 according to examples of the disclosure. A session can authenticated by the management service 135 or an identity management service. The session can be authenticated using a username and password or other authentication factors, such as a multi-factor authentication process, a passkey, or certificate-based authentication. The management service 135 can populate the session data 142 with information about the session, such as an IP address and other network information of the client device 108 when a session was initiated or created. The session data 142 can also identify a geographic location of a client device 108 when the session was initiated or created. The session data 142 can further identify other status information about the client device 108 when the session was initiated or created, such as a device type, operating system version. The management component 132 can also update the session data 142 with information about the session as it changes. In one example, the management component 132 can obtain security posture data 156 on a periodic or ongoing basis. The security posture data 156 can comprise information about the user of client device 108 that is obtained or updated during the session.

In some examples, the management service 135 can also include or execute an access system 140 and an access console 155. The access system 140 can include an application or other service that acts as a broker for client connections by authenticating a user and client device 108 as well as establishing a session for the user and client device 108. The access system 140 can include an application or other service that serves any request from a client device 108 for a session.

The management service 135 can also include an access console 155. The access console 155 can process data from user data 129, such as a user's role within an organizational hierarchy, usage logs, a user's calendar, external data sources, third party hosted services with which the user has an account and a listing of enterprise resources to which the user has access. The access console 155 can also process security posture data, such as location data associated with a client device 108, information about a network from which the client device 108 is connecting to a session, and information about the configuration of a client device 108 that is being utilized to connect to the session. The access console 155 can analyze one or more pieces of data about the security posture of a client device 108 or a user account to determine whether remedial action is needed to further secure the session.

The access console 155 can analyze security posture data 156 to determine whether an initial action is needed based upon a change in the security posture of the user or client device 108. The access console 155 can also determine whether a mitigation or remedial action is needed to further secure the session of the user.

An initial action can comprise notifying a user about a change in the security posture of the user or device based upon the access console 155. An initial action can also include imposing an expiration time on the session of the user based upon the security posture data 156 analyzed by the access console 155. In another example, the initial action could comprise pausing the session of the user. The initial action could further include blocking or terminating the session of the user. The initial action could be selected based upon an evaluation of a risk level attributable to the user or a user account of the user.

The management service 135 can permit an administrator to categorize users into different risk levels. In some examples, the management service 135 can automatically categorize users into risk levels. In one embodiment, the risk levels can be based upon the enterprise resources to which the user has access and/or a role within an organizational hierarchy, which could be determined from an analysis of an enterprise directory service. Users having access to more enterprise resources or to more sensitive enterprise resources could be deemed a higher risk level than other users who have access to very few resources or those resources that are not considered to be sensitive. In one example, users can be categorized into one of four categories: low risk, normal risk, medium risk, or high risk. An initial action can be specified for each of the risk categories based upon a particular change in security posture of the user or a client device 108 of the user that is associated with a session.

For a given change in security posture and a given risk category of the user, a particular initial action can be selected. For example, for low risk users and for a particular security posture change, a less intrusive initial action, or even no initial action, could be specified to be taken by the access console 155. For higher risk users, a more stringent or intrusive initial action could be selected because the risk to the enterprise is greater for users who have access to more or to more sensitive information within the enterprise.

In addition to an initial action, a mitigation, or a follow-up remedial action could be specified and taken on a user or client device 108 depending upon the change in the security posture reflected by the security posture data 156 and the risk level of the user. Examples of mitigations that can be required of the user or client device 108 can include acceptance or acknowledgement of a notification, reauthentication or requiring the user to provide user credentials to continue the session, providing a secondary authentication factor such as an authentication code or passcode, requiring biometric authentication of the user, or requiring an operating system update or patch.

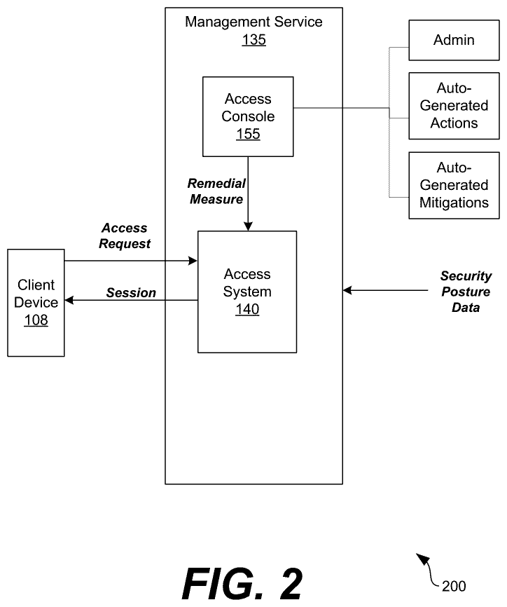

Referring to FIG. 2, shown is an alternative depiction of the management service 135, access console 155, access system 140 and a client device 108 according to an example. In the depicted scenario, the access console 155, using the security posture data 156 that is provided as an input, can determine a security posture of a session to which the user is connected. Depending upon the security posture determined for the user session and the risk level in which the user has been placed, the access console 155 can require an initial action to be taken on the user session. Additionally, the access console 155 can determine a mitigation that can be subsequently required in response to or in addition to the initial action. In some cases, an initial or first evaluation of the security posture data 156 may cause the access console 155 to determine that no action or mitigation is required. In this scenario, the first evaluation of the security posture data 156 can be a baseline evaluation from which a relative comparison of security posture data 156 can be made in a second or subsequent evaluation.

For example, the access system 140 can perform an initial authentication of a user in response to a request to create a session from a client device 108 associated with the user. The session can be a virtual desktop infrastructure (VDI) session, obtain an authentication token, or initiate a session with an enterprise service. The initial authentication can involve authenticating or verifying the client device 108 and/or user credentials. The user credential authentication can involve authenticating one or more authentication factors, such as a username, password, authentication code, or other secondary authentication factors. Once authenticated, the access system 140 can establish a session on behalf of the user.

The access console 155 can perform an ongoing or a second evaluation of security posture data 156 that can be obtained by or on behalf of the access console 155. The security posture data 156 can be obtained from the access system 140, the computing systems 106, the client device 108, and/or other software or hardware elements from which the ongoing evaluation can be performed. By performing the ongoing evaluation of the security posture data, a zero-trust framework for improving the security of the session is provided.

Continuous evaluation of information about the user, user account, client device 108 and/or network 109 through which the client device 108 is connecting to the session is performed to determine whether an initial action and remediation is needed to further secure the session. The initial action and remedial measures for a given user risk level category can be administrator configurable.

Continuous evaluation is performed by the access console 155 to verify that there is no change in the associated security posture data 156 which might increase the risk of the ongoing session being misused or hijacked. When changes are detected in the user or device posture, the existing sessions can be paused and mitigation procedures can be performed by the access console 155 or access system 140 to verify the user and allow the session to be resumed. In certain cases that involve a drastic change in the security posture of the session, the ongoing session could be terminated or restricted before resumption is permitted. The initial action and mitigation can be different based upon the user risk category.

To perform this continuous evaluation, the system obtains information on the security posture of the user, user account, network, and devices via an application installed on the client device 108, such as a management component installed on the client device 108 to locally manage the client device 108 on behalf of the management service 135. The management component can provide information about the user, client device 108 and/or network conditions associated with the client device 108 or the network 109, and information about the user. For example, the management service 135 or the management component can identify which applications are running or installed on the client device 108, which type of network connection the client device 108 is utilizing, whether a VPN is being utilized, and other aspects of the conditions under which the client device 108 is connected to the session.

The access console 155 can determine whether the user, client device 108, or other parameters are compliant with policies set forth by an administrator of the computing systems 106 and should be granted continued access to the session or whether an action or mitigation should be performed. These determinations can be made by the access console 155 based upon the state of the device as well as a risk category of the user.

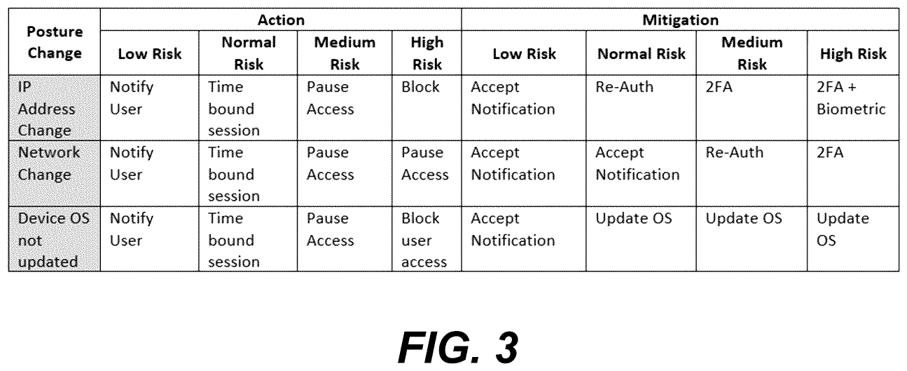

Continuing the example of FIG. 2, reference is made to FIG. 3, which shows an example of how different actions and mitigations can be specified for different risk categories of users. Information on each user such as a role of the user and the user's access to various back-end systems can be fetched through integrations with back-end enterprise systems such as a user directory, source code repositories, document management systems, or other services utilized by the enterprise to which users may have access. The risk level of the user can be measured according to the quantity or sensitivity of back-end enterprise systems to which the user has access.

For example, a junior engineer could have access to deployment or production servers. Other junior engineers may lack the same access, which means that the junior engineer can be assigned a higher risk level. Accordingly, the management service 135 or an administrator can assign the user a high risk level. Based on the role of the user and the resources to which the user has access, the user can be classified at various risk levels such as—Low Risk, Normal Risk, Medium Risk and High Risk.

The risk level calculated for the user can be a dynamic score that can immediately reflect any change in the level of access to resources held by the user. For example, a user might be instantaneously downgraded to a low risk level when the user loses access to a development server, whereas another user might be instantaneously upgraded to a medium risk level when the user is granted access to a source code repository.

As shown in FIG. 3, according to the risk level classification, the users can be associated with different initial actions and mitigations depending upon their risk level classification and the security posture data 156 change that is detected for the client device 108 or the user. Accordingly, whenever a change is detected in the user, device or network properties in the security posture data 156, instead of applying a generic action and generic mitigation, the management service 135 can apply the specific initial action based on the user's risk level and also expect a specific mitigation based upon the risk level.

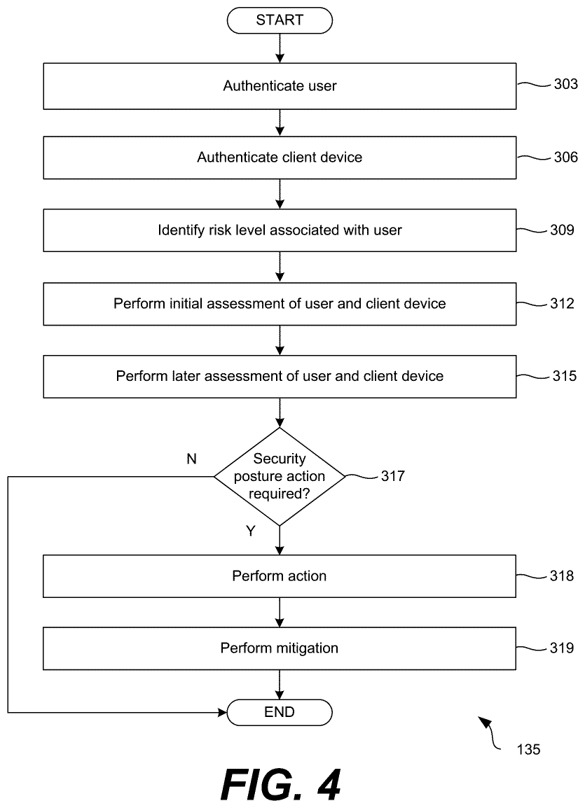

Moving on to FIG. 4, shown is a flowchart that provides one example of the operation of a portion of the networked environment 100. The flowchart of FIG. 4 can be viewed as depicting an example of elements of a method implemented by the management service 135 or the access console 155 executing in the computing environment 103 according to one or more examples. FIG. 3 illustrates how the access console 155 can provide a zero-trust model for authenticating a user's access to a session as well as the conditions under which the user is accessing the session. The separation or segmentation of functionality as discussed herein is presented for illustrative purposes only.

Beginning with step 303, the management service 135 can authenticate a session on behalf of a user. Authentication can involve authenticating one or more authentication credentials of the user, such as a username, password, secondary authentication token, a physical security key, or other authentication credential of the user.

At step 306, the management service 135 can authenticate a client device 108 of the user. The client device 108 can be authenticated using a device identifier, certificate, or other identifying information about the client device 108 with which the user is accessing a requested session.

At step 309, the management service 135 can determine a risk level associated with the user. The risk level can be determined based upon the role of a user within an organization hierarchy as identified by a user or employee directory. The risk level can also be ascertained using a quantity or sensitivity of the enterprise resources to which the user has access.

At step 312, the management service 135 can perform an initial assessment of the user or user account and client device 108. The initial assessment can evaluate the location of the client device 108, the network connection of the client device 108 to the management service 135 or another enterprise resource, the operating system of the client device 108, and other software or hardware properties of the client device 108 that the management component 132 can report to the management service 135 on behalf of the client device 108.

At step 315, the management service 135 can perform a second assessment of the user or user account and client device 108. The second assessment can evaluate the location of the client device 108, the network connection of the client device 108 to the management service 135 or another enterprise resource, the operating system of the client device 108, and other software or hardware properties of the client device 108 that the management component 132 can report to the management service 135 on behalf of the client device 108.

At step 317, the management service 135 can determine if the security posture data 156 indicates that a change in security posture necessitates an initial action. As shown in the example of FIG. 3, an administrator can establish a set of rules that specify for the various user risk levels whether an initial action is needed due to the security posture of the user or client device 108 and whether a mitigation is needed beyond the initial action. For example, the initial action can comprise generating a notification that is presented to the user on the client device 108. The notification can inform the user that the security posture of client device 108 or provide a warning about the security posture. In another example, the initial action can comprise imposing an expiration time on the session. The initial action can also comprise pausing access to the session or blocking access to the session. In some examples, for a high risk user, the initial action could be blocking access to the session. For a medium risk user, the initial action can be pausing the session. For a normal risk user, the initial action can be imposing an expiration time on the session. For a low risk user, the initial action can be generating a notification on the client device 108. Other permutations of risk level and initial action can be utilized in other implementations.

If, at step 317, the management service 135 determines that an initial action is needed because the security posture data 156 indicates that one is needed because, for example, the IP address of the client device 108 has changed, a network connection type has changed, a location of the client device 108 has changed, or the device operating system has not been updated, the process can proceed to step 318, where the management service 135 causes the initial action to be performed on the client device 108. In one example, the management component 132 can perform the action on behalf of the management service 135. If, at step 318, the management service 135 determines that the initial action is not needed, the process can proceed to completion.

From step 318, the process can proceed to step 319, where the management service 135 can perform the mitigation associated with the risk level and the change in security posture of the client device 108. Examples of mitigations that can be required of the user or client device 108 can include acceptance or acknowledgement of a notification, reauthentication or requiring the user to provide user credentials to continue the session, providing a secondary authentication factor such as an authentication code or passcode, requiring biometric authentication of the user, or requiring an operating system update or patch. Thereafter, the process can proceed to completion.

Stored in the memory device are both data and several components that are executable by the processor. Also stored in the memory can be a data store 130 and other data. A number of software components are stored in the memory and executable by a processor. In this respect, the term “executable” means a program file that is in a form that can ultimately be run by the processor. Examples of executable programs can be, for example, a compiled program that can be translated into machine code in a format that can be loaded into a random access portion of one or more of the memory devices and run by the processor, code that can be expressed in a format such as object code that is capable of being loaded into a random access portion of the one or more memory devices and executed by the processor, or code that can be interpreted by another executable program to generate instructions in a random access portion of the memory devices to be executed by the processor. An executable program can be stored in any portion or component of the memory devices including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Memory can include both volatile and nonvolatile memory and data storage components. In addition, a processor can represent multiple processors and/or multiple processor cores, and the one or more memory devices can represent multiple memories that operate in parallel processing circuits, respectively. Memory devices can also represent a combination of various types of storage devices, such as RAM, mass storage devices, flash memory, or hard disk storage. In such a case, a local interface can be an appropriate network that facilitates communication between any two of the multiple processors or between any processor and any of the memory devices. The local interface can include additional systems designed to coordinate this communication, including, for example, performing load balancing. The processor can be of electrical or of some other available construction.

Client devices 108 can be used to access user interfaces generated to configure or otherwise interact with the management service 135. These client devices 108 can include a display upon which a user interface generated by a client application for providing a virtual desktop session (or other session) can be rendered. In some examples, the user interface can be generated using user interface data provided by the computing environment 103. The client device 108 can also include one or more input/output devices that can include, for example, a capacitive touchscreen or other type of touch input device, fingerprint reader, or keyboard.

Although the management service 135 and other various systems described herein can be embodied in software or code executed by general-purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include discrete logic circuits having logic gates for implementing various logic functions upon an application of one or more data signals, application specific integrated circuits (ASICs) having appropriate logic gates, field-programmable gate arrays (FPGAs), or other components.

The sequence diagram and flowcharts show an example of the functionality and operation of an implementation of portions of components described herein. If embodied in software, each block can represent a module, segment, or portion of code that can include program instructions to implement the specified logical function(s). The program instructions can be embodied in the form of source code that can include human-readable statements written in a programming language or machine code that can include numerical instructions recognizable by a suitable execution system such as a processor in a computer system or other system. The machine code can be converted from the source code. If embodied in hardware, each block can represent a circuit or a number of interconnected circuits to implement the specified logical function(s).

Although the sequence diagram flowcharts show a specific order of execution, it is understood that the order of execution can differ from that which is depicted. For example, the order of execution of two or more blocks can be scrambled relative to the order shown. In addition, two or more blocks shown in succession can be executed concurrently or with partial concurrence. Further, in some examples, one or more of the blocks shown in the drawings can be skipped or omitted.

Also, any logic or application described herein that includes software or code can be embodied in any non-transitory computer-readable medium for use by or in connection with an instruction execution system such as, for example, a processor in a computer system or other system. In this sense, the logic can include, for example, statements including program code, instructions, and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can include any one of many physical media, such as magnetic, optical, or semiconductor media. More specific examples of a suitable computer-readable medium include solid-state drives or flash memory. Further, any logic or application described herein can be implemented and structured in a variety of ways. For example, one or more applications can be implemented as modules or components of a single application. Further, one or more applications described herein can be executed in shared or separate computing devices or a combination thereof. For example, a plurality of the applications described herein can execute in the same computing device, or in multiple computing devices.

It is emphasized that the above-described examples of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure.

What is claimed:

1. A system, comprising:
at least one computing device;
program instructions stored in memory and executable in the at least one computing device that, when executed by the at least one computing device, cause the at least one computing device to:
authenticate a user and a client device based upon at least one authentication mechanism;
establish a session between the client device and the at least one computing device in response to authentication of the user and the client device;
obtain a first security posture of the client device;
identify a risk level associated with a user account of the user;
obtain a second security posture of at least one of a network or the client device from which the client device is connecting to the session;
perform an evaluation of the risk level, the first security posture, and the second security posture;
determine that a mitigation procedure is required based upon the evaluation of the risk level, the first security posture, and the second security posture;
identify an initial action based upon the evaluation;
identify a mitigation based upon the evaluation; and
perform the mitigation to at least one the session, the user account, or the client device.

2. The system of claim 1, wherein the initial action comprises at least one of notifying a user via the client device that the second security posture requires a mitigation procedure, imposing a time limitation on the session, pausing the session until the mitigation procedure is performed, or terminating the session.

3. The system of claim 2, wherein the mitigation procedure comprises at least one of dismissing the notification, reauthenticating the user, obtaining a second authentication factor from the user, or obtaining a biometric authentication of the user.

4. The system of claim 1, wherein the first security posture is based upon a network connection of the client device and the second security posture is identified based upon a change in the network connection.

5. The system of claim 1, wherein the change in the network connection comprises at least one of a change in an internet protocol (IP) address or a change in a type of network 2 connection.

6. The system of claim 1, wherein the initial action or the mitigation is selected based upon a risk level determination for the user account.

7. The system of claim 1, wherein the risk level determination is based upon a quantity of enterprise resources to which the user account is authorized to access.

8. A non-transitory computer-readable medium embodying program code executable in at least one computing device that, when executed by the at least one computing device, causes the at least one computing device to:
authenticate a user and a client device based upon at least one authentication mechanism;
establish a session between the client device and the at least one computing device in response to authentication of the user and the client device;
obtain a first security posture of the client device;
identify a risk level associated with a user account of the user;
obtain a second security posture of at least one of a network or the client device from which the client device is connecting to the session;
perform an evaluation of the risk level, the first security posture, and the second security posture;
determine that a mitigation procedure is required based upon the evaluation of the risk level, the first security posture, and the second security posture;
identify an initial action based upon the evaluation;
identify a mitigation based upon the evaluation; and
perform the mitigation to at least one the session, the user account, or the client device.

9. The non-transitory computer-readable medium of claim 8, wherein the initial action comprises at least one of notifying a user via the client device that the second security posture requires a mitigation procedure, imposing a time limitation on the session, pausing the session until the mitigation procedure is performed, or terminating the session.

10. The non-transitory computer-readable medium of claim 9, wherein the mitigation procedure comprises at least one of dismissing the notification, reauthenticating the user, obtaining a second authentication factor from the user, or obtaining a biometric authentication of the user.

11. The non-transitory computer-readable medium of claim 8, wherein the first security posture is based upon a network connection of the client device and the second security posture is identified based upon a change in the network connection.

12. The non-transitory computer-readable medium of claim 8, wherein the change in the network connection comprises at least one of a change in an internet protocol (IP) address or a change in a type of network connection.

13. The non-transitory computer-readable medium of claim 8, wherein the initial action or the mitigation is selected based upon a risk level determination for the user account.

14. The non-transitory computer-readable medium of claim 8, wherein the risk level determination is based upon a quantity of enterprise resources to which the user account is authorized to access.

15. A method, comprising:
authenticate a user and a client device based upon at least one authentication mechanism;
establish a session between the client device and the at least one computing device in response to authentication of the user and the client device;
obtain a first security posture of the client device;
identify a risk level associated with a user account of the user;
obtain a second security posture of at least one of a network or the client device from which the client device is connecting to the session;
perform an evaluation of the risk level, the first security posture, and the second security posture;
determine that a mitigation procedure is required based upon the risk level, the first security posture, and the second security posture;
identify an initial action based upon the evaluation;
identify a mitigation based upon the evaluation; and
perform the mitigation to at least one the session, the user account, or the client device.

16. The method of claim 15, wherein the initial action comprises at least one of notifying a user via the client device that the second security posture requires a mitigation procedure, imposing a time limitation on the session, pausing the session until the mitigation procedure is performed, or terminating the session.

17. The method of claim 16, wherein the mitigation procedure comprises at least one of dismissing the notification, reauthenticating the user, obtaining a second authentication factor from the user, or obtaining a biometric authentication of the user.

18. The method of claim 15, wherein the first security posture is based upon a network connection of the client device and the second security posture is identified based upon a change in the network connection.

19. The method of claim 15, wherein the change in the network connection comprises at least one of a change in an internet protocol (IP) address or a change in a type of network connection.

20. The method of claim 19, wherein the initial action or the mitigation is selected based upon a risk level determination for the user account.
